(19) United States
(12) Patent Application Publication
(10) Pub. No.: US 2014/0014390 A1
(43) Pub. Date: Jan. 16, 2014

(54) BUSS BAR ASSEMBLY HAVING AXIALLY STACKED BUSS BAR PLATES

(71) Applicant: Remy Technologies, LLC, Pendleton, IN (US)

(72) Inventors: Bradley D. Chamberlin, Pendleton, IN (US); Cary Ramey, Greenwood, IN (US); Colin Hamer, Noblesville, IN (US)

(21) Appl. No.: 13/938,958

(22) Filed: Jul. 10, 2013

Related U.S. Application Data
(60) Provisional application No. 61/670,249, filed on Jul. 11, 2012.

(51) Int. Cl. H01B 7/00; H02K 15/00

(52) U.S. Cl. CPC H01B 7/00; H02K 15/0062
USPC 174/68.2; 29/596

(57) ABSTRACT

A buss bar assembly for a multiphase electrical machine, including a substantially annular dielectric housing having a central axis, a plurality of dielectric phase bar mounting members located within the housing, and a plurality of electrically conductive phase bars. The phase bars are disposed in the housing and substantially surround the central axis. Each phase bar has opposing, substantially planar axial sides and is in engagement with at least one phase bar mounting member. An axial side of each phase bar is in superposition with an axial side of another phase bar whereby the plurality of phase bars are axially stacked along the central axis. The phase bars have mutually spaced positions relative to each other in directions along the central axis, these positions defined by the phase bar mounting members whereby the phase bars are electrically isolated from each other within the housing.

### CROSS-REFERENCE TO RELATED APPLICATION(S)

This application claims the benefit under Title 35, U.S.C. §119(e) of U.S. Provisional Patent Application Ser. No. 61/670,249 entitled BUSS BAR ASSEMBLY HAVING AXIALLY STACKED BUSS BAR PLATES, filed on Jul. 11, 2012, the entire disclosure of which is expressly incorporated herein by reference. This application is related to U.S. Provisional Patent Application Ser. No. 61/670,249, filed on Jul. 11, 2012, and to U.S. patent application Ser. No. _____, filed on Jul. 10, 2013 (Attorney Docket No. 22888-0127 (D-654 (US)), both entitled BUSS BAR ASSEMBLY HAVING PRINTED BUSS BAR PLATES, the entire disclosures of which are incorporated herein by reference.

### BACKGROUND

The present disclosure relates to a rotating electrical device having a segmented, multiphase stator assembly that includes a plurality of individual coil winding assemblies disposed about a stator central axis and a plurality of electrical leads through which electrical power is transferred to or from the stator, such as, for example, an electric motor or generator; and more specifically, to a buss bar assembly through which the phase leads are interconnected and power is transferred.

The interconnecting of phase and neutral leads extending from a plurality of individual coil winding assemblies of the stator of a rotating electrical device (e.g., a motor or generator), which are annularly arranged about the stator central axis, is often complicated and/or time consuming. Moreover, the leads and/or their connections together or to other components can, if not properly isolated electrically, result in shorting which adversely affects device reliability.

These problems are exacerbated in multi-phase devices, wherein multiple phase power and neutral leads of different phase pluralities of individual power phase coil winding assemblies must be sorted out, electrically isolated from the leads of the coil winding assemblies of the other phases, and packaged within the stator housing, all of which have the potential to adversely affect cost and reliability.

A buss bar assembly is often employed for interconnecting the various phase and neutral leads of multiple individual coil winding assemblies, and typically promotes faster, more reliable interconnecting of the leads. However, the buss bar itself must be properly oriented, packaged and installed relative to the rest of the stator, preferably within the stator housing to protect it from externally-induced damage, and preferably in a manner that facilitates automated, consistent, and proper device assembly on a mass production scale. A buss bar assembly accommodating such preferences would represent an improvement in the relevant art and provide attendant cost and reliability advantages vis-à-vis those now used in rotating electrical devices.

### SUMMARY

A buss bar assembly and installation method according to the present invention provides such advantages, and hence represents a desirable advancement in the relevant art.

The present disclosure provides a buss bar assembly for a multiphase electrical machine, including a substantially annular dielectric housing having a central axis, a plurality of dielectric phase bar mounting members located within the housing, and a plurality of electrically conductive phase bars. Each phase bar being for electrical connection to a different one of multiple electrical phases. The phase bars are disposed in the housing and substantially surround the central axis. Each phase bar has opposing, substantially planar axial sides and is in engagement with at least one phase bar mounting member. An axial side of each phase bar is in superposition with an axial side of another phase bar whereby the plurality of phase bars are axially stacked along the central axis. The phase bars have mutually spaced positions relative to each other in directions along the central axis, these positions defined by the phase bar mounting members whereby the phase bars are electrically isolated from each other within the housing.

A further aspect of the present disclosure is that the plurality of dielectric phase bar mounting members and a portion of the substantially annular dielectric housing are integrally formed.

A further aspect of the present disclosure is that each phase bar includes a terminal for electrical connection to a different one of multiple electrical phases, the substantially annular dielectric housing defines a space in which the plurality of phase bars and the plurality of phase bar mounting members are located and a wall having openings through which the phase bar terminals extend from the space, and the housing has feet for fixing the buss bar assembly to a multiphase electrical machine stator.

A further aspect of the present disclosure is that each phase bar is provided with an aperture extending between its opposing axial sides through which a phase bar mounting member extends, and the phase bar and the phase bar mounting member are in abutting engagement at one of a plurality of different locations along the phase bar mounting member in directions along the central axis.

Another aspect of the present disclosure is that a single phase bar mounting member extends through a respective aperture through each phase bar and is in abutting engagement with each phase bar at a respective one of a plurality of different locations along the phase bar mounting member.

Another aspect of the present disclosure is that the phase bar mounting member has a substantially conical surface with which the phase bar is in abutting engagement.

Another aspect of the present disclosure is that the phase bar mounting member is defined by axially adjacent segments of different cross-sectional sizes between which is located a shoulder with which the phase bar is in abutting engagement.

A further aspect of the present disclosure is that each phase bar is provided with an aperture extending between its opposing axial sides. The apertures of successively adjacent phase bars in a direction parallel to the central axis respectively are of successively smaller sizes, and a single phase bar mounting member extends through the apertures of the plurality of phase bars. The phase bar mounting member extending through the apertures is successively smaller in size in the direction parallel to the central axis, and each phase bar and the phase bar mounting member is in abutting engagement at a respective one of a plurality of different locations along the phase bar mounting member in the direction parallel to the central axis.

Another aspect of the present disclosure is that the phase bar mounting member has a substantially conical surface with which each of the plurality of phase bars is in abutting engagement.

Another aspect of the present disclosure is that the phase bar mounting member is defined by axially adjacent segments of different cross-sectional sizes, and between each pair of axially adjacent segments is located a shoulder with which a respective one of the plurality of phase bars is in abutting engagement.

A further aspect of the present disclosure is that the buss bar assembly also includes an electrically conductive neutral bar for electrical connection to multiple electrical phases. The neutral bar is disposed in the housing and substantially surrounds the central axis. The neutral bar has opposing, substantially planar axial sides and is in engagement with at least one phase bar mounting member. An axial side of the neutral bar is in superposition with an axial side of a phase bar. Consequently, the neutral bar and the plurality of phase bars are axially stacked along the central axis, with the neutral bar and the phase bars having mutually spaced positions relative to each other in directions along the central axis defined by the phase bar mounting members, whereby the neutral bar and the phase bars are electrically isolated from each other within the housing.

Another aspect of the present disclosure is that each phase bar includes a terminal for electrical connection to a different one of multiple electrical phases, the neutral bar includes terminals for electrical connection to multiple electrical phases. The substantially annular dielectric housing defines a space in which the neutral bar, the plurality of phase bars, and the plurality of phase bar mounting members are located. The housing also defines at least one wall having openings through which the neutral bar terminals and phase bar terminals extend from the space. The housing also has feet for fixing the buss bar assembly to a multiphase electrical machine stator.

Another aspect of the present disclosure is that the neutral bar and each phase bar is provided with an aperture extending between its opposing axial sides through which a phase bar mounting member extends. At least one of the neutral bar and a phase bar, and the phase bar mounting member, are in abutting engagement at one of a plurality of different locations along the phase bar mounting member in directions along the central axis.

Moreover, an aspect of the present disclosure is that a single phase bar mounting member extends through a respective aperture through the neutral bar and each phase bar, and is in abutting engagement with the neutral bar and each phase bar at a respective one of a plurality of different locations along the phase bar mounting member.

Moreover, an aspect of the present disclosure is that the phase bar mounting member has a substantially conical surface with which at least one of the neutral bar and the phase bar is in abutting engagement.

Moreover, an aspect of the present disclosure is that the phase bar mounting member is defined by axially adjacent segments of different cross-sectional sizes between which is located a shoulder with which one of the neutral bar and the phase bar is in abutting engagement.

Another aspect of the present disclosure is that the neutral bar and each phase bar are provided with an aperture extending between its opposing axial sides. The apertures of successively adjacent ones of the neutral bar and the phase bars in a direction parallel to the central axis respectively are of successively smaller sizes, and a single phase bar mounting member extends through the apertures of the neutral bar and the plurality of phase bars. The phase bar mounting member extending through the apertures is successively smaller in size in the direction parallel to the central axis. The neutral bar and each phase bar, and the phase bar mounting member are in abutting engagement at a respective one of a plurality of different locations along the phase bar mounting member in the direction parallel to the central axis.

Moreover, an aspect of the present disclosure is that the phase bar mounting member has a substantially conical surface with which the neutral bar and each of the plurality of phase bars is in abutting engagement.

Moreover, an aspect of the present disclosure is that the phase bar mounting member is defined by axially adjacent segments of different cross-sectional sizes. Between each pair of axially adjacent segments is located a shoulder with which a respective one of the neutral bar and the phase bars is in abutting engagement.

The present disclosure also provides a method for assembling a buss bar assembly for a multiphase electrical machine. The method includes: disposing a plurality of electrically conductive phase bars, each for electrical connection to a different one of multiple electrical phases, in a substantially annular dielectric housing having a central axis, and substantially surrounding the central axis with the plurality of conductive phase bars; superposing one of a pair of opposing, substantially planar axial sides of each phase bar and one of a pair of opposing, substantially planar axial sides of another phase bar; axially stacking the plurality of phase bars along the central axis; and engaging each phase bar with at least one of a plurality of dielectric phase bar mounting members located within the housing, whereby the phase bars are positioned in mutually spaced relationships with, and electrically isolated from, each other within the housing.

A further aspect of the present disclosure is that the method also includes disposing an electrically conductive neutral bar for electrical connection to multiple electrical phases, in the housing, and substantially surrounding the central axis with the neutral bar; superposing one of a pair of opposing, substantially planar axial sides of the neutral bar and one of a pair of opposing, substantially planar axial sides of a phase bar; axially stacking the neutral bar relative to the phase bars along the central axis; and engaging the neutral bar at least one of the plurality of phase bar mounting members, whereby the neutral bar is positioned in mutually spaced relationships with, and electrically isolated from, each of the plurality of phase bars within the housing.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a partially exploded view of a buss bar assembly shown mounted to the stator of a multiphase electrical machine;

FIG. 2 is a partial, cross sectional view of a first embodiment buss bar assembly; and

FIG. 3 is a partial, cross sectional view of a second embodiment buss bar assembly.

Corresponding reference characters indicated corresponding parts throughout the several views. Although the drawings represent an embodiment, the drawing are not necessarily to scale or to the same scale and certain features may be exaggerated in order to better illustrate and explain the present invention.

### DETAILED DESCRIPTION OF EXEMPLARY EMBODIMENT(S)

The embodiments described below are not intended to be exhaustive or to limit the invention to the precise forms disclosed in the following detailed description. Rather, the embodiments are chosen and described so that others skilled in the art may appreciate and understand the principles and practices of the present invention.

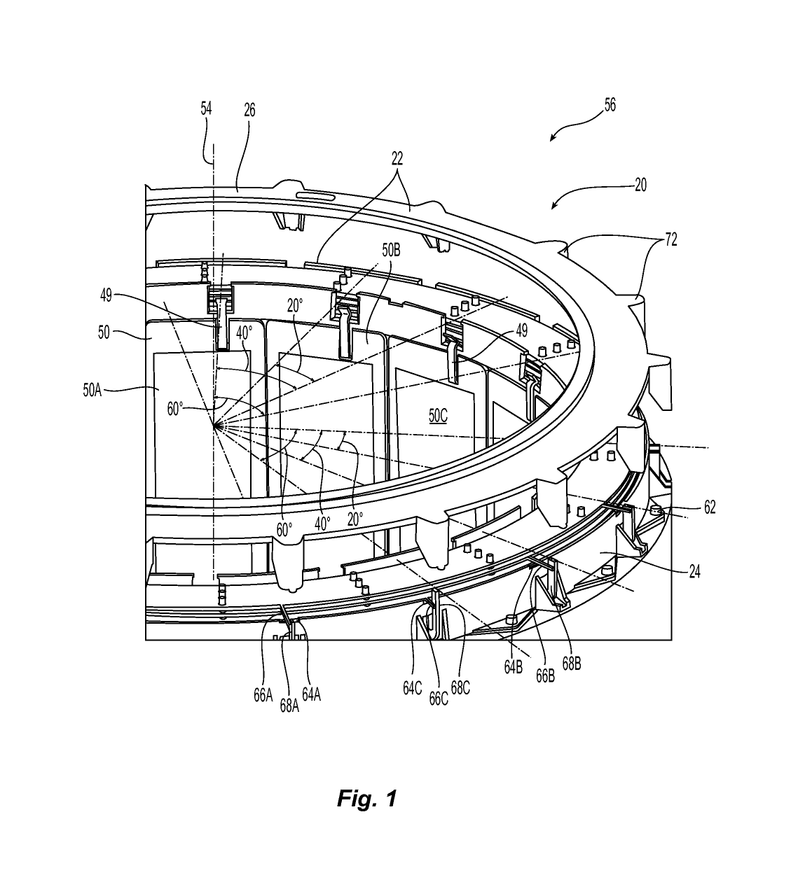

Referring to FIG. 1, Buss bar assembly 20 includes a dielectric, injection molded plastic housing 22 that has a base 24 and a separably attachable cover 26. Within housing 22 are located buss bars that include a plurality of annular phase bars 28 and optional, annular neutral bar 30. A phase bar 28 is individually connected to single electrical phase of the multiphase machine. In the depicted embodiment, there are three phases, A, B, and C; thus phase bars 28 include first phase bar 28A, second phase bar 28C, and third phase bar 28C, which are electrically isolated from each other. Each of phase bars 28A, 28B, and 28C is in electrical communication with a circumferentially distributed plurality of stator windings associated with the respective first, second, and third electrical phases, A, B, and C. The neutral bar 30 is optionally provided, and if omitted, the neutral leads of the various stator coil winding phases are interconnected with each other externally of the buss bar assembly 20.

Phase bars 28 and 30 are substantially similar, flat annular disks stamped from a copper alloy material. The layered bars 28, 30 are concentric and axially stacked or superposed such that the flat, planar sides of adjacent superposing bars are interfacing. Each of the bars 28, 30 has a plurality of circumferentially distributed sets of three apertures 32. As shown, eighteen sets of apertures 32 may be provided, spaced from each other at 20° intervals. Relative to each set of three apertures 32, the apertures 32 are radially aligned with the central axis of the annular bar 28, 30, and are equally spaced radially. The apertures 32 are all configured as right cylinders whose central axes are parallel and normal to the flat opposing side surfaces of the bars 28, 30. Between the different phase bars 28 and the neutral bar 30, the diameters of the apertures are different. First phase bar 28A has apertures 32 of diameter D_{A}, second phase bar 28B has apertures 32 of diameter D_{B}, third phase bar 28C has apertures 32 of diameter D_{C}, and neutral bar 30 has apertures 32 of diameter D_{N}. Diameter D_{A} is smaller than diameter D_{B}; diameter D_{B} is smaller than diameter D_{C}; and diameter D_{C} is smaller than diameter D_{N}.

The stacked or layered bars 28, 30 have substantially cylindrical radially inner edges 34 and radially outer edges 36, which may be respectively aligned axially. First phase bar 28A has radial edges 34A and 36A; second phase bar 28B has radial edges 34B and 36B; third phase bar 28C has radial edges 34C and 36C; and neutral bar 30 has radial edges 34N and 36N. The layered bars 28, 30 are axially spaced from each other, thereby electrically isolating them. One or more compressible, electrically insulative spacers 38 may be interposed between adjacent, axially superposed bars 28, 30 to ensure their axial spacing is maintained. Insulators may, for example, be made of a suitable rubber. Alternatively, the spacer/insulator(s) 38 may be formed of a dielectric resin, such as varnish, that is injected as a liquid between adjacent bars 28, 30, and allowed to cure to a substantially rigid consistency. Insulators 38 thus prevent movement of a bar 28, 30 upwardly and into contact with an overlying bar 28.

Housing base 24 is provided with a plurality of circumferentially distributed sets of three bar mounting members or pins 40. As shown, eighteen sets of bar mounting pins 40 may be provided, spaced from each other at 20° intervals. Relative to each set of three pins 40, the pins 40 are radially aligned with the central axis of the annular housing base 24, and are equally spaced radially. The pins 40 are all configured to provide varying diameters along their length, and have a substantially right frustoconical shape. The central axes of the pins 40 are parallel and project normally relative to the flat surfaces of the bars 28, 30.

First phase bar 28A has apertures 32 of diameter D_{A}, second phase bar 28B has apertures 32 of diameter D_{B}, third phase bar 28C has apertures 32 of diameter D_{C}, and neutral bar 30 has apertures 32 of diameter D_{N}. Diameter D_{A} is smaller than diameter D_{B}; diameter D_{B} is smaller than diameter D_{C}; and diameter D_{C} is smaller than diameter D_{N}.

The radially inner cylindrical wall of the housing base 24 may be provided as shown with a circumferentially distributed plurality of radially inner openings 42, if the buss bar assembly includes a neutral bar 30. The flat, annular, mutually superposing bars 28, 30 respectively lie in axially spaced, parallel planes 44. Neutral bar 30 substantially lies in plane 44N, which is located beneath planes 44A, 44B, and 44C in which phase bars 28A, 28B, and 28C substantially lie, respectively. The bottommost edge portion 46 defining each opening 42 is located below plane 44N, i.e., on the side of plane 44N away from housing cover 26. Each opening 42 is also defined by an opposed pair of circumferentially spaced side edge portions 48. Thus, with cover 26 attached to base 24, a window is defined through which at least the radially inner edge 34N of neutral bar 30 is a terminal accessible from outside of the housing 22. When the buss bar assembly 20 is installed relative to the stator, a neutral lead terminal 49 extending from each coil winding assembly 50 abuttingly engages the edge or terminal 34N of the neutral bar 30 through the opening 42.

The coil winding assemblies 50 define a plurality 52 of coil winding assemblies alternatingly arranged by electrical phase A, B, C about the axis 54 of a stator assembly 56, which coincides with the buss bar assembly central axis. Thus, stator 56 has an equal number (here, six) of first phase coil winding assemblies 50A, second phase coil winding assemblies 50B, and third phase coil winding assemblies 50C; the individual coil winding assemblies 50A, 50B, or 50C are interconnected through their respective phase bar 28A, 28B, or 28C when the buss bar assembly 20 is installed onto the arranged plurality of coil winding assemblies 52. The buss bar housing base 24 includes a circumferentially distributed plurality of first feet 28, each of which is provided with an aperture 60. The coil winding assemblies 50 each include an injection molded insulator from which extends an integral retention pin 62 that is received into the housing base foot aperture 60. Subsequent to retention pin insertion through the first feet 58, the terminal ends of the pins 62 are plastically deformed to provide a head larger than the diameter of aperture 60, and thereby fixing the buss bar assembly to the stator 56.

The radially outer cylindrical wall of the housing base 24 (shown partially removed in FIG. 1) is provided with a circumferentially distributed plurality of radially outer openings 64. The flat, annular phase bars 28 may each be provided, as shown, with a circumferentially distributed plurality of integral phase terminals 66A, 66B, or 66C that projects radially outwardly in the respective plane 44 through associated opening 64A, 64B, or 64C. Phase lead terminals 68 extend from the coil winding assemblies 50, and electrically engage a respective one of the buss bar assembly phase terminals 66. Thus, first phase lead terminals 68A of coil winding assemblies 50A electrically engage first phase bar 28A through connections to first phase terminals 66A; second phase lead terminals 68B of coil winding assemblies 50B electrically engage second phase bar 28B through connections to second phase terminals 66B; and third phase lead terminals 68C of coil winding assemblies 50C electrically engage third phase bar 28C through connections to third phase terminals 66C.

The buss bar housing base 24 has second feet 70 through which the phase lead terminals 68 extend and which partially electrically isolate the terminals 68. Shields 72 formed on the injection molded plastic housing cover 26 cooperate with the housing base second feet 70 to enclose the connection between the phase bar terminals 66 and the phase lead terminals 68, and more fully electrically isolate the these terminals.

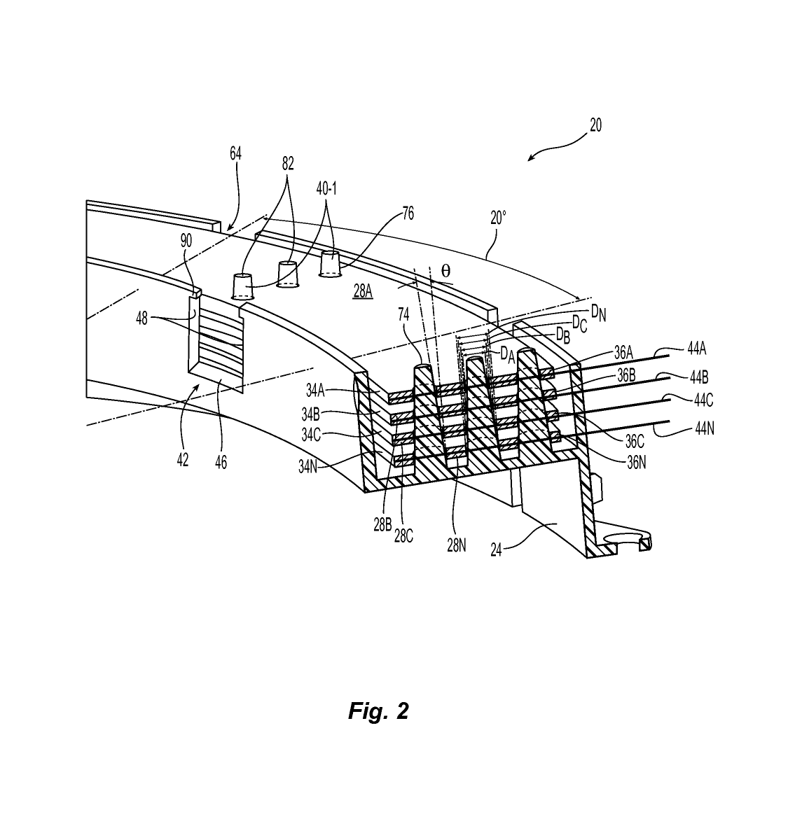

Referring to FIG. 2, a first embodiment buss bar assembly 20 has bar mounting members or pins 40-1 that extend along parallel central axes 74, with each pin 40-1 having a smoothly tapering outer surface 76. In a plane extending along the pin central axis 74, the surface 76 defines a straight line disposed at an acute angle θ relative to the axis 74. With bars 28A, 28B, 28C, and 30 disposed in layers on pins 40-1, the lowermost circular edges of apertures 32 have line-to-line contact with surface 76 at locations along axis 74 at which the diameter of pin 40-1 is D_{A}, D_{B}, D_{C}, and D_{N}, respectively. Thus, axial spacing of the stacked bars 28, 30 is established through the circular edges of their apertures 32 abutting pin surface 76. As noted above, an insulative spacer 38 may be provided between axially adjacent bars 28, 30 to prevent upward movement towards, and contact with, another bar 28 within the housing 22.

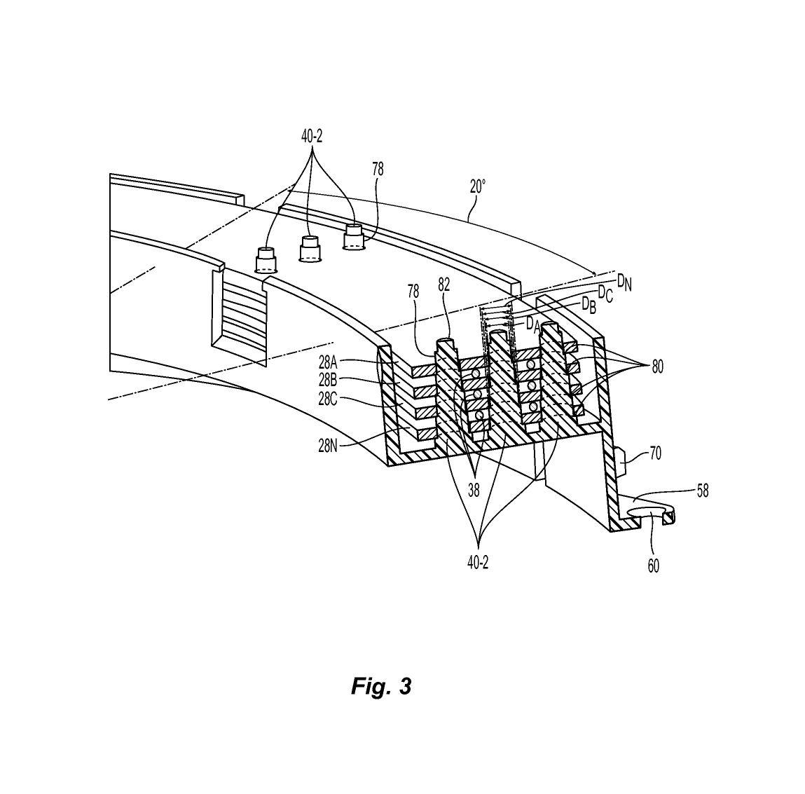

Referring to FIG. 3, a second embodiment buss bar assembly 20 has bar mounting members or pins 40-2 that extend along parallel central axes 74, with each pin 40-2 having a segmented surface 78 defined by right cylindrical portions of diameters received into bar apertures 32A, 32B, 32C, and/or 32N, closely fitting their right cylindrical aperture diameters D_{A}, D_{B}, D_{C}, and D_{N}. The annular axial surface of each adjacent, larger diameter segment of pin 40-2 defines a shoulder 80. With bars 28A, 28B, 28C, and 30 disposed on pins 40-2, the bottom side surfaces have surface-to-surface contact with a corresponding shoulder 80 at spaced locations along axis 74. Thus, axial spacing of the stacked bars 28, 30 is established through the abutting contact of the bar bottom surfaces and mounting pin annular shoulders 80. As noted above, a spacer 38 may be provided between axially adjacent bars 28, 30 to prevent upward movement towards, and contact with, another bar 28 within the housing 22.

The terminal end or tip 82 of each bar mounting pin 40 engages the interior side of the housing cover 26. An insulative spacer 38 also may be provided between phase bar 28A and cover 26 to axially restrain the stacked bars 28, 38 and other spacers 38 within the housing 22.

The housing base 24 and cover 26 may be interconnected and retained together through snap lock features 90 provided on base 24 and cooperating features (not shown) in the cover 26.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A buss bar assembly for a multiphase electrical machine, comprising:
a substantially annular dielectric housing having a central axis;
a plurality of dielectric phase bar mounting members located within the housing; and
a plurality of electrically conductive phase bars, each for electrical connection to a different one of multiple electrical phases, disposed in the housing and substantially surrounding the central axis, each phase bar having opposing, substantially planar axial sides and in engagement with at least one phase bar mounting member, an axial side of each phase bar in superposition with an axial side of another phase bar whereby the plurality of phase bars are axially stacked along the central axis, the phase bars having mutually spaced positions relative to each other in directions along the central axis defined by the phase bar mounting members whereby the phase bars are electrically isolated from each other within the housing.

2. The buss bar assembly of claim 1, wherein the plurality of dielectric phase bar mounting members and a portion of the substantially annular dielectric housing are integrally formed.

3. The buss bar assembly of claim 1, wherein each phase bar includes a terminal for electrical connection to a different one of multiple electrical phases, and the substantially annular dielectric housing defines a space in which the plurality of phase bars and the plurality of phase bar mounting members are located and a wall having openings through which the phase bar terminals extend from the space, the housing having feet for fixing the buss bar assembly to a multiphase electrical machine stator.

4. The buss bar assembly of claim 1, wherein each phase bar is provided with an aperture extending between its opposing axial sides through which a phase bar mounting member extends, and the phase bar and the phase bar mounting member are in abutting engagement at one of a plurality of different locations along the phase bar mounting member in directions along the central axis.

5. The buss bar assembly of claim 4, wherein a single phase bar mounting member extends through a respective aperture through each phase bar and is in abutting engagement with each phase bar at a respective one of a plurality of different locations along the phase bar mounting member.

6. The buss bar assembly of claim 4, wherein the phase bar mounting member has a substantially conical surface with which the phase bar is in abutting engagement.

7. The buss bar assembly of claim 4, wherein the phase bar mounting member is defined by axially adjacent segments of different cross-sectional sizes between which is located a shoulder with which the phase bar is in abutting engagement.

8. The buss bar assembly of claim 1, wherein each phase bar is provided with an aperture extending between its opposing axial sides, the apertures of successively adjacent phase bars in a direction parallel to the central axis respectively being of successively smaller sizes, and a single phase bar mounting member extends through the apertures of the plurality of phase bars, the phase bar mounting member extending through the apertures successively smaller in size in the direction parallel to the central axis, each phase bar and the phase bar mounting member being in abutting engagement at a respective one of a plurality of different locations along the phase bar mounting member in the direction parallel to the central axis.

9. The buss bar assembly of claim 8, wherein the phase bar mounting member has a substantially conical surface with which each of the plurality of phase bars is in abutting engagement.

10. The buss bar assembly of claim 8, wherein the phase bar mounting member is defined by axially adjacent segments of different cross-sectional sizes, and between each pair of axially adjacent segments is located a shoulder with which a respective one of the plurality of phase bars is in abutting engagement.

11. The buss bar assembly of claim 1, further comprising an electrically conductive neutral bar for electrical connection to multiple electrical phases, the neutral bar disposed in the housing and substantially surrounding the central axis, the neutral bar having opposing, substantially planar axial sides and in engagement with at least one phase bar mounting member, an axial side of the neutral bar in superposition with an axial side of a phase bar whereby the neutral bar and the plurality of phase bars are axially stacked along the central axis, the neutral bar and the phase bars having mutually spaced positions relative to each other in directions along the central axis defined by the phase bar mounting members whereby the neutral bar and the phase bars are electrically isolated from each other within the housing.

12. The buss bar assembly of claim 11, wherein each phase bar includes a terminal for electrical connection to a different one of multiple electrical phases, the neutral bar includes terminals for electrical connection to multiple electrical phases, and the substantially annular dielectric housing defines a space in which the neutral bar, the plurality of phase bars, and the plurality of phase bar mounting members are located and at least one wall having openings through which the neutral bar terminals and phase bar terminals extend from the space, the housing having feet for fixing the buss bar assembly to a multiphase electrical machine stator.

13. The buss bar assembly of claim 11, wherein the neutral bar and each phase bar is provided with an aperture extending between its opposing axial sides through which a phase bar mounting member extends, and at least one of the neutral bar and a phase bar, and the phase bar mounting member, are in abutting engagement at one of a plurality of different locations along the phase bar mounting member in directions along the central axis.

14. The buss bar assembly of claim 13, wherein a single phase bar mounting member extends through a respective aperture through the neutral bar and each phase bar and is in abutting engagement with the neutral bar and each phase bar at a respective one of a plurality of different locations along the phase bar mounting member.

15. The buss bar assembly of claim 13, wherein the phase bar mounting member has a substantially conical surface with which at least one of the neutral bar and the phase bar is in abutting engagement.

16. The buss bar assembly of claim 13, wherein the phase bar mounting member is defined by axially adjacent segments of different cross-sectional sizes between which is located a shoulder with which one of the neutral bar and the phase bar is in abutting engagement.

17. The buss bar assembly of claim 11, wherein the neutral bar and each phase bar is provided with an aperture extending between its opposing axial sides, the apertures of successively adjacent ones of the neutral bar and the phase bars in a direction parallel to the central axis respectively being of successively smaller sizes, and a single phase bar mounting member extends through the apertures of the neutral bar and the plurality of phase bars, the phase bar mounting member extending through the apertures successively smaller in size in the direction parallel to the central axis, the neutral bar and each phase bar, and the phase bar mounting member being in abutting engagement at a respective one of a plurality of different locations along the phase bar mounting member in the direction parallel to the central axis.

18. The buss bar assembly of claim 17, wherein the phase bar mounting member has a substantially conical surface with which the neutral bar and each of the plurality of phase bars is in abutting engagement.

19. The buss bar assembly of claim 17, wherein the phase bar mounting member is defined by axially adjacent segments of different cross-sectional sizes, and between each pair of axially adjacent segments is located a shoulder with which a respective one of the neutral bar and the phase bars is in abutting engagement.

20. A method for assembling a buss bar assembly for a multiphase electrical machine, comprising:
disposing a plurality of electrically conductive phase bars, each for electrical connection to a different one of multiple electrical phases, in a substantially annular dielectric housing having a central axis, and substantially surrounding the central axis with the plurality of conductive phase bars;
superposing one of a pair of opposing, substantially planar axial sides of each phase bar and one of a pair of opposing, substantially planar axial sides of another phase bar;
axially stacking the plurality of phase bars along the central axis; and
engaging each phase bar with at least one of a plurality of dielectric phase bar mounting members located within the housing, whereby the phase bars are positioned in mutually spaced relationships with, and electrically isolated from, each other within the housing.

21. The method of claim 20, further comprising:
disposing an electrically conductive neutral bar for electrical connection to multiple electrical phases, in the housing, and substantially surrounding the central axis with the neutral bar;
superposing one of a pair of opposing, substantially planar axial sides of the neutral bar and one of a pair of opposing, substantially planar axial sides of a phase bar;
axially stacking the neutral bar relative to the phase bars along the central axis; and
engaging the neutral bar at least one of the plurality of phase bar mounting members, whereby the neutral bar is positioned in mutually spaced relationships with, and electrically isolated from, each of the plurality of phase bars within the housing.
